(19) United States
(12) Patent Application Publication
(10) Pub. No.: US 2024/0421303 A1
(43) Pub. Date: Dec. 19, 2024

(54) Porous Carbon/Semiconductor Nanowire Particulates for Battery Applications and Production Process

(71) Applicant: Honeycomb Battery Company, Dayton, OH (US)

(72) Inventor: Bor Z. Jang, Centerville, OH (US)

(73) Assignee: Honeycomb Battery Company, Dayton, OH (US)

(21) Appl. No.: 18/335,230

(22) Filed: Jun. 15, 2023

(51) Int. Cl. H01M 4/583; H01M 4/04; H01M 10/0525; H01M 10/054

(52) U.S. Cl. CPC H01M 4/583; H01M 4/0416; H01M 4/0471; H01M 10/0525; H01M 10/054; H01M 2004/021

(57) ABSTRACT

A plurality of porous carbon/semiconductor nanowire particulates and production processes, wherein a particulate comprises (i) a porous carbon matrix or shell; (ii) semiconductor nanowires dispersed in the carbon matrix or encapsulated by the carbon shell, wherein the nanowires have a diameter or thickness from 5 nm to 1 μm (preferably from 10 nm to 500 nm); and (iii) pores surrounded by or adjacent to the semiconductor nanowires; wherein the semiconductor nanowires occupy a weight fraction from 1% to 99% of the particulate and the semiconductor material and the catalytic metal form an eutectic point in a phase diagram; and wherein the pores have a non-zero residual pore volume, Vₚ, unoccupied by the carbon or semiconductor nanowires and the semiconductor nanowires have a total volume of Vₙ, having a Vₚ/Vₙ ratio from 0.01 to 10 (preferably from 0.1 to 5.0 and most preferably from 0.3 to 4.0).

### FIELD

This invention relates to semiconductor nanowire-containing porous carbon particles, an anode comprising such porous carbon-nanowire particles, lithium-ion battery or sodium-ion battery comprising such an anode, and production processes.

### BACKGROUND

Lithium ion battery is a prime candidate energy storage device for electric vehicle (EV), renewable energy storage, and smart grid applications. Graphite materials have been widely used as an anode active material for commercial lithium-ion batteries due to their relatively low cost and excellent reversibility. However, the theoretical lithium storage capacity of graphite is only 372 mAh/g (based on LiC₆), which can limit the total capacity and energy density of a battery cell. The emerging EV and renewable energy industries demand the availability of rechargeable batteries with a significantly higher energy density and power density than what the current Li ion battery technology can provide. Hence, this requirement has triggered considerable research efforts on the development of electrode materials with higher specific capacity, excellent rate capability, and good cycle stability for lithium-ion batteries.

Several elements from Group III, IV, and V in the periodic table can form alloys with Li at certain desired voltages. Therefore, various anode materials based on such elements (e.g. Si, Ge, Sn, Sb, etc.), their compounds, and some metal oxides (e.g., SnO₂) have been proposed for lithium ion batteries. Among these, silicon is considered the most promising one since it has the highest theoretical specific capacity (up to 4,200 mAh/g in the stoichiometric form of Li_{4.4}Si) and low discharge potential (i.e., high operation potential when paired with a cathode).

However, using Si as an example, the dramatic volume changes (up to 380%) of Si during lithium ion alloying and de-alloying (cell charge and discharge) often led to severe and rapid battery performance deterioration. The performance fade is mainly due to the volume change-induced pulverization of Si and the inability of the binder/conductive additive to maintain the electrical contact between the pulverized Si particles and the current collector. In addition, the intrinsically low electric conductivity of silicon and other semiconductor materials is another challenge that needs to be addressed. Thus far, many attempts have been made to improve the electrochemical performance of Si-based anode materials, which include (1) reducing particle size to the nano-scale (<100 nm), such as Si nanoparticles, nanowires, or thin film, to reduce the total strain energy, which is a driving force for crack formation in the particle; (2) depositing Si particles on a highly electron-conducting substrate; (3) dispersing Si particles in an active or non-active matrix; and (4) coating Si particles with a layer of carbon. Although some promising anodes with specific capacities in excess of 1,000 mAh/g (at a low charge/discharge rate; e.g. 0.1 C) have been reported, it remains challenging to retain such high capacities over cycling (e.g., for more than 100 cycles) without significant capacity fading. Furthermore, at a higher C rate, Si particles and other high-capacity anode active material (Ge, Sn, etc.) are typically incapable of maintaining a high lithium storage capacity. It may be noted that a rate of n C means completing the charge or discharge cycle in 1/n hours: 0.1 C=10 hours, 0.5 C=2 hours, 3 C=⅓ hours or 20 minutes.

Although nano-scaled anode active materials, such as Ge nanoparticles, Si nanowires, and Sn nano films, are promising high-capacity anode materials, these materials remain too expensive to be economically viable. Again, using Si as an example, common methods used for producing silicon nano powders include plasma-enhanced chemical vapor deposition (PECVD), laser-induced pyrolysis of SiH₄, and hot-wire synthesis methods. From mass production and cost perspectives, current processes for producing nano Si powder have been time-consuming and energy-intensive, also typically requiring the use of high-vacuum, high-temperature, and/or high-pressure production equipment. The resulting Si nano powder products have been extremely expensive and this cost issue has severely impeded the full-scale commercialization of Si nano powder materials. Hence, there exists a strong need for a more cost-effective process for producing Si nano powder (e.g. Si nanowires or nano particles) in large quantities.

For instance, U.S. Pat. No. 7,615,206 issued on Nov. 10, 2009 to K. H. Sandhage and Z. H. Bao provides methods for the production of shaped nanoscale-to-microscale silicon through partially or completely converting a nanoscale-to-microscale silica template by using magnesium vapor. Magnesiothermic reduction of silica requires much lower temperatures (normally in the range of 600-800° C.) compared with the carbothermal reduction of silica (normally over 2000° C.) and thus has become a relatively popular technique used in pure metal production. Silicon is obtained by the following reaction: 2 Mg+SiO₂→2MgO+Si. However, this process must be conducted under a high pressure condition and there is the danger of explosion not just during the reaction procedure (due to pressure vessel weakness), but also after the reaction is presumably completed when the reactor is opened (ultra-fast reaction of un-used Mg with air). Furthermore, when using Mg vapor to chemically reduce silica, magnesium silicide could be easily formed and, hence, this process is not suitable for mass production. Using magnesium powder will add to cost of producing nano-sized silicon and the particle size of magnesium could dramatically influence the reduction results and purity.

As a totally distinct class of energy storage device, sodium (Na) batteries have been considered an attractive alternative to lithium batteries since sodium is abundant and the production of sodium is significantly more environmentally benign compared to the production of lithium. In addition, the high cost of lithium is a major issue and Na batteries potentially can be of significantly lower cost.

There are at least two types of batteries that operate on bouncing sodium ions (Na⁺) back and forth between an anode and a cathode: the sodium metal battery having Na metal or alloy as the anode active material and the sodium-ion battery having a Na intercalation compound as the anode active material. Sodium ion batteries using a hard carbon-based anode active material (a Na intercalation compound) and a sodium transition metal phosphate as a cathode have been described by several research groups; e.g., J. Barker, et al. “Sodium Ion Batteries,” U.S. Pat. No. 7,759,008 (Jul. 20, 2010).

However, these sodium-based devices exhibit even lower specific energies and rate capabilities than Li-ion batteries. The anode active materials for Na intercalation and the cathode active materials for Na intercalation have lower Na storage capacities as compared with their Li storage capacities. For instance, hard carbon particles are capable of storing Li ions up to 300-360 mAh/g, but the same materials can store Na ions up to 150-250 mAh/g. Graphite typically stores significantly less than 150 mAh/g of sodium ions (often less than 40 mAh/g) even though graphite can store up to 370 mAh/g of lithium.

Instead of hard carbon or other carbonaceous intercalation compound, sodium metal may be used as the anode active material in a sodium metal cell. However, the use of metallic sodium as the anode active material is normally considered undesirable and dangerous due to the dendrite formation, interface aging, and electrolyte incompatibility problems. Further, sodium is known as a highly explosive substance.

Silicon (Si), several other semiconductor materials, semi-metal materials, and compounds thereof, can be good candidate anode materials for a sodium-ion battery. However, Si suffers from some severe problems induced by Si volume changes when the sodium-ion cell is charged and discharged. An anode active material is normally used in a powder form, which is mixed with conductive additives and bonded by a binder resin. The binder also serves to bond the mixture to a current collector. Alternatively, an anode active material may be coated as a thin film onto a current collector. On repeated charge and discharge operations, the Si particles tend to undergo pulverization and the current collector-supported thin films are prone to fragmentation due to expansion and contraction of the anode active material (Si) during the insertion and extraction of sodium ions. This pulverization or fragmentation results in loss of particle-to-particle contacts between the active material and the conductive additive or contacts between the anode material and its current collector. These adverse effects result in a significantly shortened charge-discharge cycle life. In addition to Si, other elements, such as Ge, Sn. Bi, Sb, Pb, P, their alloys (e.g., SnGe, SnSb, NiSb, and SnGeSb), and their compounds (e.g., Sn₄P₃ and SnO₂), are also candidate anode materials for sodium-ion batteries and they also suffer from similar issues as Si, but to varying degrees.

Herein, we present a facile and cost-effective method of mass-producing semiconductor nanowires inside pores of carbon particles. This new class of materials and related production methods reduce or avoid all the issues associated with using high-capacity anode materials in a lithium-ion cell or sodium-ion cell.

### SUMMARY

The present disclosure provides a plurality of porous carbon/semiconductor nanowire particulates, wherein at least a particulate has a particle size from 50 nm to 1 mm and comprises (i) a porous carbon matrix or shell; (ii) semiconductor nanowires dispersed in the carbon matrix or encapsulated by the carbon shell, wherein the nanowires have a diameter or thickness from 5 nm to 1 μm (preferably from 10 nm to 500 nm); and (iii) pores surrounded by or adjacent to the semiconductor nanowires; wherein the semiconductor nanowires occupy a weight fraction from 1% to 99% of the particulate and the semiconductor material and the catalytic metal form an eutectic point in a phase diagram; and wherein the pores have a non-zero residual pore volume, Vₚ, unoccupied by the carbon or semiconductor nanowires and the semiconductor nanowires have a total volume Vₙ, having a Vₚ/Vₙ ratio from 0.01 to 10 (preferably from 0.1 to 5.0 and most preferably from 0.3 to 4.0).

Preferably and typically, the surfaces of semiconductor nanowires are coated with a layer of carbon, which is contiguous with or connected to the carbon matrix or shell.

Preferably, the semiconductor comprises a material selected from Si, Ga, In, Ge, Sn, Pb, P, As, Sb, Bi, Te, a compound thereof, an alloy thereof, or a combination thereof. The compounds of these semiconductor materials include, as examples, the III-VI compounds (e.g. InP, GaAs, GaP, etc.) and oxides, borides, carbides, nitrides of these elements, such as GaN.

The porous carbon/semiconductor nanowire particulates may further comprise a catalyst metal that is dispersed inside the particulate and selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof, wherein the catalytic metal is different in composition than the semiconductor material.

In certain embodiments, the carbon comprises amorphous carbon (e.g., carbon from physical vapor deposition or laser ablation), CVD carbon (carbon produced from chemical vapor deposition), sputtering carbon (carbon produced via sputtering), polymeric carbon (carbon produced from carbonizing or pyrolyzing a synthetic or natural polymer), activated carbon, carbon from petroleum or coal pitch, graphite, or a combination thereof.

Typically, the semiconductor material and the catalytic metal form a eutectic point, as defined in a metallurgical phase diagram, during the nanowire formation procedure.

In some embodiments, the particulates further comprise an electron-conducting polymer or an ion-conducting polymer permeating into or residing in the pores of these porous particulates wherein the ion-conducting polymer has an electric conductivity greater than 10⁻⁸ S/cm or the ion-conducting polymer has a lithium-ion or sodium-ion conductivity greater than 10⁻⁸ S/cm. Essentially any polymer that meets this conductivity can be used to practice the present disclosure.

The ion-conducting polymer may be preferably selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The electron-conducting polymer is preferably selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

The present disclosure also provides a battery electrode (e.g., anode) containing multiple porous carbon/semiconductor nanowire particulates. Further provided is a lithium battery or sodium battery containing multiple porous carbon/semiconductor nanowire particulates as an anode active material.

The present disclosure further provides a process for producing a plurality of porous carbon/semiconductor nanowire particulates, the process comprising: (A) preparing composite particles comprising particles of a semiconductor coated with a catalyst metal or a catalyst metal precursor, wherein the catalytic metal or the catalytic metal precursor is in the form of nano particles having a size from 1 nm to 200 nm or a coating having a thickness from 1 nm to 200 nm, coated on surfaces of said semiconductor particles, having a size of 20 nm to 1 mm (preferably from 50 nm to 100 μm and further preferably from 100 nm to 10 μm), and wherein said semiconductor is selected from Si, Ga, In, Ge, Sn, Pb, P, As, Sb, Bi, Te, a compound thereof, an alloy thereof, or a combination thereof; (B) combining the composite particles with a carbon precursor material to form multiple carbon precursor-protected composite particles wherein a carbon precursor-protected composite particle comprises one or more than one catalytic metal- or catalytic metal precursor-coated semiconductor particles that are dispersed in a matrix of the carbon precursor or encapsulated by a shell of the carbon precursor; and (C) exposing the multiple carbon precursor-protected composite particles to a high temperature environment, from 100° C. to 2,500° C., for a period of time sufficient to enable (i) a catalytic metal-assisted growth of multiple semiconductor nanowires, having a diameter or thickness from 2 nm to 1000 nm, from the semiconductor particles and (ii) conversion of the carbon precursor to carbon, forming the porous carbon/semiconductor nanowire particulates.

The starting micron or sub-micron scaled semiconductor particles can have a diameter from 0.2 μm to 50 μm, but preferably from 0.5 μm to 5 μm, and more preferably <3 μm.

In certain embodiments, in the invented process, the step of depositing a catalytic metal includes (i) dissolving or dispersing a catalytic metal precursor in a liquid to form a precursor solution, (ii) bringing the precursor solution in contact with surfaces of the carbon filaments and/or semiconductor particles. (iii) removing the liquid component; and (iv) chemically or thermally converting the catalytic metal precursor to the catalytic metal coating or metal nano particles. In one embodiment, the step (iv) of chemically or thermally converting the catalytic metal precursor is conducted concurrently with the procedure (C) of exposing the polymer-protected catalyst metal-coated particles to a high temperature environment.

In the process, the step (d) of chemically or thermally converting the catalytic metal precursor may be conducted concurrently with the procedure (C) of exposing the particulates to a high temperature environment.

In certain embodiments, the catalytic metal precursor is a salt or organo-metal molecule of a metal (including metalloid) selected from Cu, Ni, Co, Mn, Fc, Ti, Al, Ag, Au, Pt, Pd, Pb, Bi, Sb, Zn, Cd, Ga, In, Zr, Te, P, Sn, Ge, Si, Ge, Si, or a combination thereof. The catalytic metal includes not only metal elements but also metalloid elements, such as Al, Ge, Si, Sb, Sn, and Ti.

In some preferred embodiments, the catalytic metal precursor is selected from a nitrate, acetate, sulfate, phosphate, hydroxide, or carboxylate of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

In some embodiments, the catalytic metal precursor is selected from a nitrate, acetate, sulfate, phosphate, hydroxide, or carboxylate of a transition metal.

The step (C) of exposing the carbon- or carbon precursor-protected catalyst metal-coated semiconductor material to a high temperature environment is preferably conducted in steps, including at least at a lower temperature (first temperature) for a first period of time and then at a higher temperature (second temperature) for a second period of time. These temperatures can include a first temperature from 100° C. to 1,000° C. and a second temperature from 300° C. to 2,500° C. The heat treatment at the first temperature is mainly aimed at reducing the metal precursor (e.g., a metal salt) to a metal phase or to activate the metal coated on semiconductor material. The heat treatment at the second temperature is aimed at building a thermodynamic environment conducive to initiation and growth of semiconductor nanowires from the semiconductor particles. The required high temperature range depends on the catalytic metal used, given the same semiconductor material.

In certain embodiments, the semiconductor material and the pairing catalytic metal form a eutectic point in the corresponding phase diagram and the procedure of exposing the catalyst metal-coated semiconductor material to a high temperature environment includes exposing the material to a temperature equal to or higher than the eutectic point for a desired period of time and then bringing the material to a temperature below the eutectic point. In some embodiments, the exposure temperature is higher than the eutectic temperature by 0.5 to 500 degrees in Celsius scale (preferably by 1-50 degrees centigrade).

During these procedures, semiconductor nanowires are kind of extruded out from the starting semiconductor particles and emanate from a center of the semiconductor particle. The semiconductor nanowires produced in this manner typically have a diameter less than 100 nm and a length-to-diameter aspect ratio of at least 5 (more typically l/d=10-10,000 and most typically 100-1,000).

Preferably, the catalytic metal precursor is a salt or organo-metal molecule of catalytic metal precursor is a salt or organo-metal molecule of a metal selected from Cu, Ni, Co, Mn, Fc, Ti, Al, Ag, Au, Pt, Pd, Pb, Bi, Sb, Zn, Cd, Ga, In, Zr, Te, P, Sn, Ge, Si, or a combination thereof. Examples of the precursors include copper nitrate, nickel nitrate, cobalt nitrate, manganese nitrate, iron nitrate, titanium nitrate, aluminum nitrate, copper acetate, nickel acetate, cobalt acetate, manganese acetate, iron acetate, titanium acetate, aluminum acetate, copper sulfate, nickel sulfate, cobalt sulfate, manganese sulfate, iron sulfate, titanium sulfate, aluminum sulfate, copper phosphate, nickel phosphate, cobalt phosphate, manganese phosphate, iron phosphate, titanium phosphate, aluminum phosphate, copper hydroxide, nickel hydroxide, cobalt hydroxide, manganese hydroxide, iron hydroxide, titanium hydroxide, aluminum hydroxide, copper carboxylate, nickel carboxylate, cobalt carboxylate, manganese carboxylate, iron carboxylate, titanium carboxylate, aluminum carboxylate, or a combination thereof.

The catalytic metal (including metalloid) is preferably selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof. They can be produced from the aforementioned precursors. Alternatively, the deposition of catalytic metal can be accomplished more directly. Thus, in an embodiment, the step of depositing a catalytic metal is conducted by a procedure of physical vapor deposition, chemical vapor deposition, sputtering, plasma deposition, laser ablation, plasma spraying, ultrasonic spraying, printing, electrochemical deposition, electrode plating, electrodeless plating, chemical plating, ball milling, or a combination thereof.

The procedure of exposing the catalyst metal-coated materials to a high temperature environment may be conducted in a protective atmosphere of an inert gas, nitrogen gas, hydrogen gas, a mixture thereof, or in a vacuum.

The presently invented process may further comprise a procedure of removing the catalytic metal from the carbon/semiconductor nanowires particulates after the nanowires are produced; for instance, via chemical etching, electrochemical etching, etc.

The process may further comprise a procedure of mixing porous particulates with a carbonaceous or graphitic material (as a conductive additive) and an optional binder material to form a battery electrode layer, wherein the carbonaceous or graphitic material is selected from a chemical vapor deposition carbon, physical vapor deposition carbon, amorphous carbon, chemical vapor infiltration carbon, polymeric carbon or carbonized resin, pitch-derived carbon, natural graphite, artificial graphite, meso-phase carbon, meso-phase pitch, meso-carbon micro-bead, soft carbon, hard carbon, coke, carbon fiber, carbon nano-fiber, carbon nano-tube, carbon black, or a combination thereof.

The process may further comprise a procedure of impregnating pores of the porous carbon/semiconductor nanowire particulates with an ion-conducting or electron-conducting polymer.

### BRIEF DESCRIPTION OF THE DRAWINGS

FIG. 1(A) A flow chart showing a preferred route to preparing semiconductor nanowires (2-1,000 nm in diameter or thickness) from particles of the same semiconductor material inside pores of a carbon particle (having a diameter from 50 nm to 100 μm) according to certain embodiments of the disclosure using Ge as an example of the semiconductor material.

FIG. 1(B) Schematic illustrating a preferred route to preparing semiconductor nanowires from particles of the same semiconductor material inside pores of a carbon particle according to certain embodiments of the disclosure using Si as an example of the semiconductor material.

FIG. 2 Phase diagram of the Bi—Sn system.

FIG. 3 Phase diagram of the Al—Ge system.

FIG. 4 Phase diagram of the Au—Si system.

FIG. 5(A) SEM image of Si nanowires grown from Si particles without the presence of carbon matrix or encapsulating carbon shell.

FIG. 5(B) SEM image of Si nanowires grown from Si particles with the presence of protecting carbon.

FIG. 6 SEM image of Ge nanowires.

FIG. 7 SEM image of Sn nanowires.

### DETAILED DESCRIPTION

The present disclosure provides a plurality of porous carbon/semiconductor nanowire particulates, wherein at least a particulate has a particle size from 50 nm to 1 mm and comprises (i) a porous carbon matrix or shell; (ii) semiconductor nanowires dispersed in the carbon matrix or encapsulated by the carbon shell, wherein the nanowires have a diameter or thickness from 5 nm to 1 μm (preferably from 10 nm to 500 nm, more preferably less than 200 nm, and most preferably less than 100 nm); and (iii) pores surrounded by or adjacent to the semiconductor nanowires; wherein the semiconductor nanowires occupy a weight fraction from 1% to 99% of the particulate and the semiconductor material and the catalytic metal form an eutectic point in a phase diagram; and wherein the pores have a non-zero residual pore volume, Vₚ, unoccupied by the carbon or semiconductor nanowires and the semiconductor nanowires have a total volume Vₙ, having a Vₚ/Vₙ ratio from 0.01 to 10 (preferably from 0.1 to 5.0 and most preferably from 0.3 to 4.0). Preferably and typically, the surfaces of semiconductor nanowires are coated with a layer of carbon, which is contiguous with or connected to the carbon matrix or shell.

Preferably, the semiconductor comprises a material selected from Si, Ga, In, Ge, Sn, Pb, P, As, Sb, Bi, Te, a compound thereof, an alloy thereof, or a combination thereof. The compounds of these semiconductor materials include the III-VI compounds (e.g., InP, GaAs, GaP, etc.) and oxides, borides, carbides, nitrides of these elements, such as GaN.

The presently disclosed porous carbon/semiconductor nanowire particulates, when used as an electrode active material in a lithium-ion battery or sodium-ion battery deliver the following advantageous features:
1) Semiconductor materials typically do not have a high electric conductivity. By embracing, coating, or encapsulating the semiconductor with a carbon material, one can significantly improve the electrical conductivity of a battery electrode (e.g., anode containing Si or Ge as an anode active material). Furthermore, carbon materials are typically permeable to lithium ions as well.
2) By converting larger semiconductor particles (e.g., micron- or millimeter-sized Si, Ge, and Sn particles) into nanowires (having a thin diameter less than 200 nm, for instance), one can reduce or eliminate the severe problem of particle pulverization during battery charges/discharges, which is known to result in fast capacity decay of a battery containing such particles.
3) The pores surrounding the semiconductor nanowires provide room to accommodate volume expansion of nanowires during battery charges, reducing or eliminating the volume expansion of a battery electrode or that of a cell.

The porous carbon/semiconductor nanowire particulates may further comprise a catalyst metal that is dispersed inside the particulate and selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof, wherein the catalytic metal is different in composition than the semiconductor material. This catalyst metal participates in the nanowire production process and can be allowed to stay in the particulate or can be removed after nanowires are formed.

In certain embodiments, the carbon comprises a carbonaceous material selected from amorphous carbon (e.g., carbon from physical vapor deposition or laser ablation), CVD carbon (carbon produced from chemical vapor deposition), sputtering carbon (carbon produced via sputtering), polymeric carbon (carbon produced by carbonizing or pyrolyzing a synthetic or natural polymer), activated carbon, carbon from petroleum or coal pitch, graphite, or a combination thereof.

In some embodiments, the particulates further comprise an electron-conducting polymer or an ion-conducting polymer permeating into pores of the porous particulates wherein the ion-conducting polymer has an electric conductivity greater than 10⁻⁸ S/cm or the ion-conducting polymer has a lithium-ion or sodium-ion conductivity greater than 10⁻⁸ S/cm. These polymers are incorporated to help build and maintain 3-D networks of electron- and ion-conducting paths.

The ion-conducting polymer may be preferably selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

The electron-conducting polymer is preferably selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

The present disclosure also provides a battery electrode (e.g., an anode) containing multiple porous carbon/semiconductor nanowire particulates. Further provided is a lithium battery or sodium battery containing multiple porous carbon/semiconductor nanowire particulates as an anode active material.

The present disclosure also provides a process for producing a plurality of porous carbon/semiconductor nanowire particulates, the process comprising: (A) preparing composite particles comprising particles of a semiconductor coated with a catalyst metal or a catalyst metal precursor, wherein the catalytic metal or the catalytic metal precursor is in the form of nano particles having a size from 1 nm to 200 nm or a nano-coating having a thickness from 1 nm to 200 nm, coated on surfaces of the semiconductor particles, having a size of 20 nm to 1 mm (preferably from 50 nm to 100 μm and further preferably from 100 nm to 10 μm), and wherein the semiconductor is selected from Si, Ga, In, Ge, Sn, Pb, P, As, Sb, Bi, Te, a compound thereof, an alloy thereof, or a combination thereof; (B) combining the composite particles with a carbon precursor material (e.g., a polymer or pitch) to form multiple carbon precursor-protected composite particles wherein a carbon precursor-protected composite particle comprises one or more than one catalytic metal- or catalytic metal precursor-coated semiconductor particles that are dispersed in a matrix of the carbon precursor or encapsulated by a shell of the carbon precursor; and (C) exposing the multiple carbon precursor-protected composite particles to a high temperature environment, from 100° C. to 2,500° C., for a period of time sufficient to enable (i) a catalytic metal-assisted growth of multiple semiconductor nanowires, having a diameter or thickness from 2 nm to 1000 nm, from the semiconductor particles and (ii) conversion of the carbon precursor to carbon, forming the porous carbon/semiconductor nanowire particulates. The catalytic metal precursor (e.g., copper nitrate) is typically converted into the metal catalyst (e.g., Cu) during the heating process.

The present invention provides a process for initiating and growing semiconductor nanowires (inside pores of carbon particles) from micron or sub-micron scaled semiconductor particles having an original particle diameter (prior to nanowire growth) from 50 nm to 500 μm (preferably from 100 nm to 20 μm). In other words, the starting material is micron-(or larger) or sub-micron scaled semiconductor particles, which are thermally and catalytically converted directly into nano-scaled, wire-shaped structures having a diameter or thickness from 2 nm to 1,000 nm (more typically <100 nm).

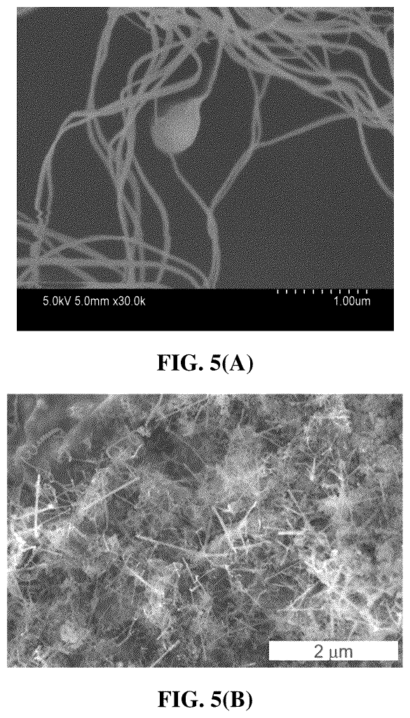

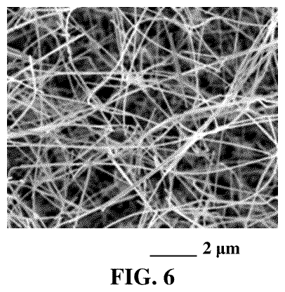

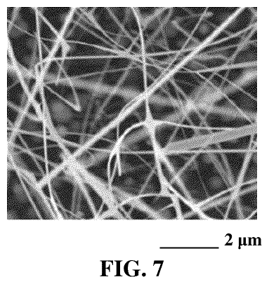

Studies using scanning electron microscopy (SEM) indicate that tens of nanowires can be grown or “extruded out” from a starting solid semiconductor particle. As an example, FIG. 5(A) shows that tens of Si nanowires have been sprouted or emanated from each Si particle that was originally 2-5 μm in diameter. These Si nanowires have drawn the needed Si atoms from the few starting Si particles. By spitting out a large number of nanowires, the original Si particles, if smaller than 2 μm in diameter, were fully expended. When larger particles having an original diameter >3 μm were used, there were typically some residual Si particles left. By spitting out such a large number of nanowires, the original Si particles were reduced to approximately 0.2-0.6 μm in diameter. With the presence of carbon matrix or shell, essentially all the micron or sub-micron Si particles are totally “eaten up”; there is typically no residual Si particles left and there are a huge number of finer Si nanowires produced (e.g., FIG. 5(B)). SEM images of Ge nanowires and Sn nanowires are shown in FIG. 6 and FIG. 7, respectively.

There are several advantages associated with the presently disclosed process. For instance, there is no chemical reaction (such as converting SiH₄ into Si in a CVD process) and the process does not involve any undesirable chemical, such as silane, which is toxic and explosive. The process can concurrently generate the desired pores in a carbon particle and allow a certain amount of carbon to be deposited onto surfaces of semiconductor nanowires.

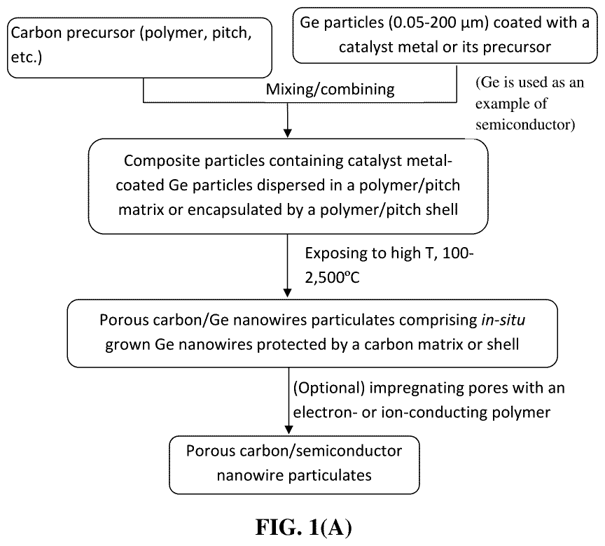

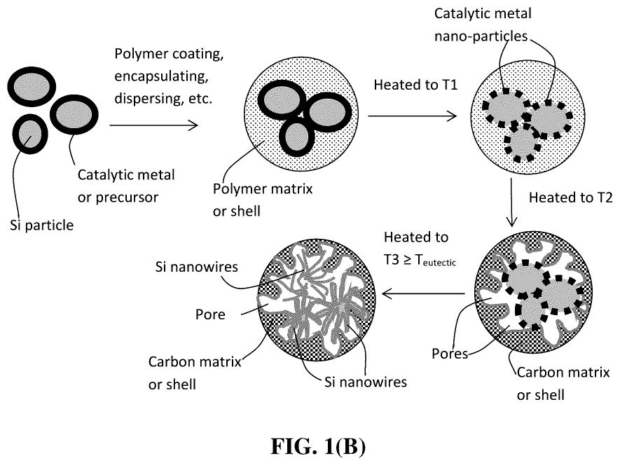

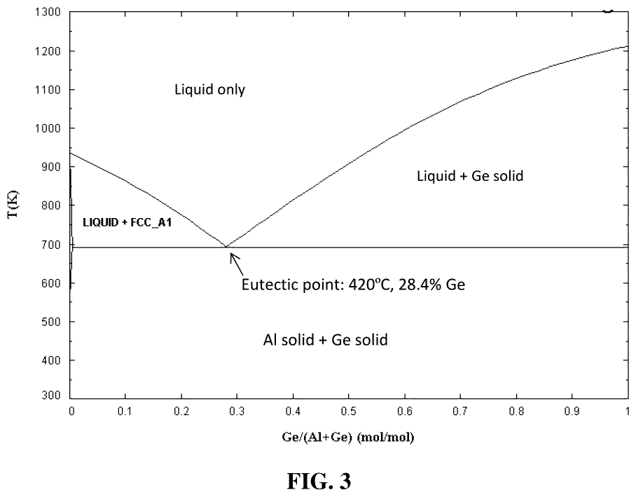

In some preferred embodiments, as illustrated in FIGS. 1(A) and 1(B), this process begins by preparing catalyst metal- or catalyst metal precursor-coated semiconductor particles (e.g., Ge and Si particles). These coated particles and a polymer (as a carbon precursor) are then combined in such a manner that the coated particles are dispersed in a polymer matrix or encapsulated by a polymer shell to form secondary particles or particulates. Each secondary particle can comprise one catalyst-coated semiconductor particle or multiple coated semiconductor particles protected by a polymer shell; e.g., in FIG. 1(B), three coated particles are shown to be encapsulated by a polymer shell or matrix as an example. The catalyst metal precursor (e.g., titanium acetate, aluminum acetate, etc.) is typically converted into catalytic metal (e.g., Ti, Al, etc.) during the subsequent heat treatment (e.g., heated to be above a first temperature, T₁), as illustrated in FIG. 1(B). These particulates are then heated to a second temperature (T₂) to carbonize the polymer, producing carbon-protected catalyst metal-coated semiconductor particles (e.g., catalytic Al-coated Ge particles encapsulated by a carbon shell). During the polymer carbonization procedure, pores are naturally produced since certain non-carbon elements are removed. Sequentially or concurrently, catalytic metal-assisted growth of semiconductor nanowires occurs if T₂ is higher than a eutectic point (T_{eutectic}) of the catalytic metal-semiconductor phase diagram (e.g., eutectic point at 420° C. and 28.4% Ge shown in the phase diagram, FIG. 3) or if the particulates are further heated to a temperature above T_{eutectic}, at some point of the procedure. In many cases, the surfaces of growing semiconductor nanowires are naturally coated with a carbon layer.

The catalytic metal is preferably in the form of a nano-scaled coating (having a thickness less than 100 nm, preferably less than 50 nm, more preferably less than 10 nm, and further preferably less than 5 nm, and most preferably 1-2 nm) or nano-scaled particles (having a diameter less than 100 nm, preferably less than 50 nm, more preferably less than 10 nm, and further preferably less than 5 nm, and most preferably 1-2 nm). Thinner metal coating or smaller particles of metal are more effective in producing a larger number of smaller semiconductor nanowires, which are preferred features when it comes to using semiconductor nanowires as an anode active material of a lithium-ion or sodium-ion battery.

When the catalyst metal-coated semiconductor particles are exposed to a high temperature environment, T>T_{eutectic} (preferably from 100° C. to 2,500° C., more preferably from 200° C. to 1,500° C., and most preferably and typically from 300° C. to 1,200° C.) for a period of time, catalytic metal-catalyzed growth of multiple semiconductor nanowires occurs. These semiconductor nanowires are emanated or extruded out from the semiconductor particles, which act as the source or feedstock material for the growing semiconductor nanowires to feed on. Additionally, larger numbers of semiconductor nanowires appear to emanate from surfaces of carbon shell or matrix when present. This is most striking because there was no semiconductor material pre-deposited on surfaces of the carbon phase. The resulting particulate is a porous composite structure composed of semiconductor nanowires (possibly plus residual metal nano particles) residing in pores of a porous carbon structure. The semiconductor nanowires have a diameter from 1 nm to 1,000 nm (typically from 5 to 200 nm and more typically 10-50 nm) and a length that is typically 1-1000 μm (more typically 1-20 μm).

The starting semiconductor particles preferably have a diameter from 100 nm to 10 μm, more preferably <3 μm. The starting semiconductor particles are preferably spherical, cylindrical, or platelet (disc, ribbon, etc.) in shape, but can be of any shape. Semiconductor particles of various shapes and various particle sizes are commercially available.

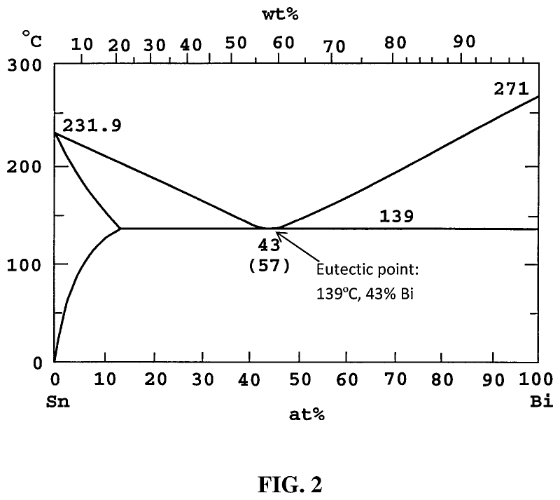

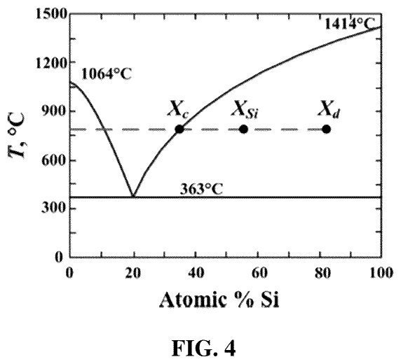

It may be noted that this high temperature range depends on the catalytic metal used. Three examples are used herein to illustrate the best mode of practice. Shown in FIG. 2, FIG. 3, and FIG. 4 are phase diagrams of the Sn—Bi, Ge—Al, and Au—Si systems, respectively. In the first example, Sn is the semiconductor material and Bi is the catalyst metal and, in the second example, Ge is the semiconductor and Al is the catalyst metal. In the third example, Si is the semiconductor and Au is the catalytic metal.

In the Sn—Bi binary system, there exists a eutectic point at a eutectic temperature Te=139° C. and eutectic composition Ce=46% (atomic percentage of Bi). A mass of Bi-coated Sn particles residing in pores of a carbon particle may be slowly heated to above Te (e.g. a high temperature from 139.5° C. to 230° C., lower than both the melting temperature of the semiconductor, 231.9° C., and the melting temperature of the catalyst metal, 271° C.). The heating rate can be from 1 to 100 degrees/min (centigrade scale). One can allow the Bi-coated Sn particles to stay at this high temperature (say 170° C.) for 1 minute to 3 hours and then cool the material down to 145° C. (slightly above Te) and/or even 135° C. (slightly below Te) for 1-180 minutes. This will lead to the formation of Sn nanowires from the coated Sn particles.

In the Ge—Al binary system, there exists a eutectic point at a eutectic temperature Te=420° C. and eutectic composition Ce=71.6% (atomic percentage of Al). A mass of Al-coated Ge particles embedded in porous carbon particles may be slowly heated to above Te (e.g. a high temperature from 421° C. to 600° C., lower than both the melting temperature of the semiconductor, 938.2° C., and the melting temperature of the catalyst metal, 660.3° C.). The heating rate can be from 1 to 100 degrees/min (centigrade scale). One can allow the Al-coated Ge particles and to stay at this high temperature (say 460° C.) for 1 minute to 3 hours and then cool the material down to 430° C. (slightly above Te) and/or even 415° C. (slightly below Te) for 1-180 minutes. This will lead to the formation of Ge nanowires from the coated Sn particles. Alternatively, one may choose to cool the materials slowly down from 460° C. (after staying at this temperature for a desired period of time) to room temperature.

In some embodiments, the step of depositing a catalytic metal includes: (a) dissolving or dispersing a catalytic metal precursor in a liquid to form a precursor solution; e.g. dissolving nickel nitrate, Ni(NO₃)₂, in water; (b) bringing the precursor solution in contact with surfaces of semiconductor particles; e.g. immersing the particles into the Ni(NO₃)₂-water solution; (c) removing the liquid component; e.g. vaporizing water of the Ni(NO₃)₂-water solution, allowing Ni(NO₃)₂ to coat on the surfaces of the semiconductor particles; and (d) chemically or thermally converting the catalytic metal precursor (e.g. Ni(NO₃)₂) to the catalytic metal coating or metal nano particles; e.g. by heating the Ni(NO₃)₂-coated mass at 450-650° C. in a reducing environment (e.g. in a flowing gas mixture of hydrogen and argon).

In one embodiment, the step (d) of chemically or thermally converting the catalytic metal precursor is conducted concurrently with the step of exposing the catalyst metal-coated semiconductor particles and the embracing carbon precursor (polymer or pitch) to a high temperature environment. Such a temperature also acts to carbonize the polymer or pitch and the catalytic metal presumably would also get to deposit onto the carbon walls.

In certain embodiments, the catalytic metal precursor is a salt or organo-metal molecule of a metal selected from Cu, Ni, Co, Mn, Fc, Ti, Al, Ag, Au, Pt, Pd, Pb, Bi, Sb, Zn, Cd, Ga, In, Zr, Te, P, Sn, Ge, Si, or a combination thereof. In some preferred embodiments, the catalytic metal precursor is selected from a nitrate, acetate, sulfate, phosphate, hydroxide, or carboxylate of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

The catalytic metal precursor may be selected from a nitrate, acetate, sulfate, phosphate, hydroxide, or carboxylate of a transition metal. In certain embodiments, for instance, the catalytic metal precursor is selected from copper nitrate, nickel nitrate, cobalt nitrate, manganese nitrate, iron nitrate, titanium nitrate, aluminum nitrate, copper acetate, nickel acetate, cobalt acetate, manganese acetate, iron acetate, titanium acetate, aluminum acetate, copper sulfate, nickel sulfate, cobalt sulfate, manganese sulfate, iron sulfate, titanium sulfate, aluminum sulfate, copper phosphate, nickel phosphate, cobalt phosphate, manganese phosphate, iron phosphate, titanium phosphate, aluminum phosphate, copper carboxylate, nickel carboxylate, cobalt carboxylate, manganese carboxylate, iron carboxylate, titanium carboxylate, aluminum carboxylate, or a combination thereof. Given the same semiconductor particles, different types of precursor require different temperatures and/or chemical reactants for conversion to the catalytic metal phase. Different catalytic metals enable semiconductor nanowire growth at different temperatures.

The step of depositing a catalytic metal on the surfaces of semiconductor particles may also be conducted by a procedure of physical vapor deposition (PVD), chemical vapor deposition (CVD), sputtering, plasma deposition, laser ablation, plasma spraying, ultrasonic spraying, printing, electrochemical deposition, electrode plating, electrodeless plating, chemical plating, ball milling, or a combination thereof.

There are known processes that can be used to combine a polymer or pitch (as a carbon precursor) with semiconductor particles (e.g., Si or Ge particles) to form polymer- or pitch-encapsulated semiconductor particles. For instance, three broad categories of micro-encapsulation methods can be implemented to produce polymer-encapsulated particulates of metal catalyst-coated semiconductor particles: physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

Pan-coating method: The pan coating process involves tumbling the catalytic metal- or metal precursor-coated semiconductor particles in a pan or a similar device while the encapsulating material (e.g. monomer/oligomer, polymer melt, polymer/solvent solution) is applied slowly until a desired encapsulating shell thickness is attained.

Air-suspension coating method: In the air suspension coating process, the coated semiconductor particles (core material) are dispersed into the supporting air stream in an encapsulating chamber. A controlled stream of a polymer-solvent solution (polymer or its monomer or oligomer dissolved in a solvent; or its monomer or oligomer alone in a liquid state) is concurrently introduced into this chamber, allowing the solution to hit and coat the suspended particles. These suspended particles are encapsulated (fully coated) with polymers while the volatile solvent is removed, leaving a layer of polymer (polymer or its precursor, which is cured/hardened subsequently) on surfaces of these particles. This process may be repeated several times until the required parameters, such as full-coating thickness (i.e. encapsulating shell or wall thickness), are achieved. The air stream which supports the particles also helps to dry them, and the rate of drying is directly proportional to the temperature of the air stream, which can be adjusted for optimized shell thickness.

In a preferred mode, the particles in the encapsulating zone portion may be subjected to re-circulation for repeated coating. Preferably, the encapsulating chamber is arranged such that the particles pass upwards through the encapsulating zone, then are dispersed into slower moving air and sink back to the base of the encapsulating chamber, enabling repeated passes of the particles through the encapsulating zone until the desired encapsulating shell thickness is achieved.

Centrifugal extrusion: Metal-coated semiconductor particles may be encapsulated using a rotating extrusion head containing concentric nozzles. In this process, a stream of core fluid (slurry containing coated semiconductor particles dispersed in a solvent) is surrounded by a sheath of shell solution or melt. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle method: Core-shell encapsulation or matrix-encapsulation of coated semiconductor particles can be conducted using a laminar flow through a nozzle and vibration of the nozzle or the liquid. The vibration has to be done in resonance with the Rayleigh instability, leading to very uniform droplets. The liquid can consist of any liquids with limited viscosities (1-50,000 mPa·s): emulsions, suspensions or slurry containing the coated semiconductor particles. The solidification can be conducted according to the used gelation system with an internal gelation (e.g. sol-gel processing, melt) or an external (additional binder system, e.g. in a slurry).

Spray-drying: Spray drying may be used to encapsulate coated semiconductor particles when the coated semiconductor particles are suspended in a melt or polymer solution. In spray drying, the liquid feed (solution or suspension) is atomized to form droplets which, upon contacts with hot gas, allow solvent to get vaporized and thin polymer shell to fully embrace the solid particles of the active material.

These processes can produce secondary particles or composite particles comprising one or multiple metal- or metal salt-coated semiconductor particles that are encapsulated by a polymer shell or are dispersed in a polymer matrix.

The procedure of exposing the catalyst metal-coated mixture mass to a high temperature environment is preferably conducted in a protective or reducing atmosphere of an inert gas, nitrogen gas, hydrogen gas, a mixture thereof, or in a vacuum.

The present process appears to enable semiconductor nanowires to grow from both original semiconductor particle surfaces and pore wall surfaces of carbon matrix or shell embracing the metal-coated semiconductor particles. A highly unexpected observation is the notion that a huge number of semiconductor nanowires appear to grow out of surfaces of carbon as well. These semiconductor nanowires appear to emanate from these carbon shell surfaces everywhere, even though that typically there was no pre-deposited semiconductor material on these surfaces and there were limited initial contact points between carbon and original semiconductor particles (i.e., there was very limited amount of semiconductor on carbon surfaces embracing the semiconductor particles). With the presence of carbon, the number of semiconductor nanowires is typically 1 or 2 orders of magnitude larger than that in the samples containing semiconductor particles alone, without the presence of metal-coated carbon. Additionally, the resulting semiconductor nanowires are significantly smaller in diameter, typically thinner than 35 nm (more typically from 2 nm to 20 nm), in contrast to the typically >35 nm (more typically >50 nm and most typically >60 nm) for those semiconductor nanowires grown directly from original semiconductor particles. These are highly desirable attributes considering that smaller semiconductor nanowire diameters imply shorter diffusion paths for lithium ions or sodium ions and, hence, faster charge and discharge procedures for the lithium-ion or sodium-ion batteries.

If so desired, the process may further comprise a procedure of removing the residual catalytic metal from the semiconductor nanowires; for instance, via chemical etching or electrochemical etching.

In a desired embodiment, the process of producing semiconductor nanowires is followed by a procedure of mixing particles of a carbonaceous or graphitic material with the plurality of porous carbon/semiconductor nanowire particulates in the preparation of an anode electrode. This carbonaceous or graphitic material may be selected from a chemical vapor deposition carbon, physical vapor deposition carbon, amorphous carbon, chemical vapor infiltration carbon, polymeric carbon or carbonized resin, pitch-derived carbon, natural graphite, artificial graphite, meso-phase carbon, meso-phase pitch, meso-carbon micro-bead, soft carbon, hard carbon, coke, carbon fiber, carbon nano-fiber, carbon nano-tube, carbon black, or a combination thereof.

The following examples are provided for the purpose of illustrating the best mode of practicing the present invention and should not be construed as limiting the scope of the instant invention. The selection of the following semiconductor materials as examples is based on the consideration that they have a high specific capacity when used as an anode active material: Li₄Si (3,829 mAh/g), Li_{4.4}Ge (1,623 mAh/g), Li_{4.4}Sn (993 mAh/g), and Li₃Sb (660 mAh/g).

### Example 1: Preparation of Metal Salt-Coated Ge Particles Enclosed by a Polymer and Porous Carbon/Ge Nanowire Particulates

Three samples were prepared. A desired amount of Ge particles was immersed in a solution of nickel nitrate, iron nitrate, and copper acetate in water, respectively. Water was subsequently removed to form metal salt-coated Ge particles. On a separate basis, polystyrene foam (Styrofoam) cups were cut into pieces and dissolved in acetone to form a solution. The metal salt-coated Ge particles were then immersed in the polymer solution for 5 minutes and retreated and dried in an oven for 2 hours to form polymer-encapsulated metal salt-coated Ge particles.

The polymer-protected, metal salt-coated Ge particles were then exposed to a reducing atmosphere of H₂ and Ar gas and subjected to a desired temperature profile, typically from room temperature to a reduction temperature of approximately 300-700° C. (for reduction of nickel nitrate to Ni nano coating, for instance). The temperature was continued to rise to a final temperature of 762-900° C. for 3 hours and the system was allowed to cool down naturally. Massive amounts of Ge nanowires were found to emanate from Ge particles inside carbon shells. The diameter of the Ge nanowires was observed to be from approximately 23 nm to 39 nm.

### Comparative Example 1a: Nickel-Assisted Growth of Ge Nanowires from Ge Particles

Ge particles were immersed in a solution of nickel nitrate or nickel acetate in water. Water was subsequently removed and the dried particles were coated with a thin layer of nickel nitrate or nickel acetate. These metal precursor-coated Ge particles were then exposed to a heat treatment in a reducing atmosphere of H₂ and Ar gas according to a desired temperature profile. This profile typically included from room temperature to a reduction temperature of approximately 300-700° C. (for reduction of nickel nitrate or acetate to Ni nano coating, for instance). The temperature was continued to rise to a final temperature of 762-900° C. for 3 hours and the system was allowed to cool down naturally. Nickel metal catalyst-assisted growth of Ge nanowires from Ge particles was found to occur. The diameter of Ge nanowires produced was in the range of 47 nm to 77 nm.

### Example 2: Preparation of Porous Carbon Particles Comprising Si Nanowires Grown Inside Pores of Carbon Particles

A desired amount of nickel sulfate was dissolved in water to form a metal salt solution. Si particles (approximately 6 μm in size) were then added to the metal salt solution. Water was allowed to vaporize at 60° C. to form nickel sulfate salt-coated Si particles. The resulting coated particulates were then subjected to heat treatments at a temperature of 450-650° C. for 1-2 hours, forming thin Ni film-encapsulated Si particles. Polyethylene oxide (PEO) was dissolved in water to form a polymer solution containing 2.5% by weight of PEO. Ni film-encapsulated Si particles were then dispersed in this PEO solution to form a slurry, which was spray-dried to form a powder sample of secondary particles that each comprise PEO-protected Ni film-encapsulated Si particles.

The powder was then subjected to heat treatments by ramping the temperature to 650° C. at a rate of 5 degrees/minute and stayed at 650° C. for 2 hours to carbonize PEO, creating a porous carbon structure due to evolution of volatile reaction product species (e.g., CO₂, H₂O, etc.). The temperature was continued to rise to a final temperature of 1,020° C. and the system was allowed to cool down naturally. Si nanowires were found to emanate from both existing Si particles and carbon pore walls.

### Example 3: Copper-Assisted Growth of Sb Nanowires from Sb Particles Inside Porous Carbon Particles

The work began with the preparation of antimony (Sb) particles, which entailed mixing Sb₂O₃ particles with small activated carbon (AC) particles using ball milling. By beating the resulting mixture in a sealed autoclave and heating the mixture to 950° C., antimony was obtained from the oxide by a carbothermal reduction: 2 Sb₂O₃+3 C→4 Sb+3 CO₂. The Sb particles produced typically resided in pores of AC, which could be recovered by breaking up the AC particles with ball-milling, if so desired.

The AC particles having Sb particles residing in pores of the AC particles were immersed in a solution of copper acetate in water. Water was subsequently removed, allowing copper acetate to precipitate out and coat on both Sb particles and carbon pore walls. These AC particulates containing metal precursor-coated Sb particles were then exposed to a heat treatment in a reducing atmosphere of H₂ and Ar gas according to a desired temperature profile. This profile typically included from room temperature to a reduction temperature of approximately 300-600° C. (for reduction of copper acetate to Cu nano coating). The temperature was continued to rise to a final temperature of 526-620° C. for 1-3 hours. The system was allowed to cool down to 520° C. for 1 hour and then cooled down naturally to room temperature, resulting in copper metal catalyst-assisted growth of Sb nanowires from Sb particles inside activated carbon pores.

The porous composite particulates were further impregnated with sulfonated polyaniline by using a solution immersion procedure.

### Example 4: Zinc-Assisted Growth of Sn Nanowires from Sn Particles Inside Pores of a Carbon Particle

Tin particles were coated with a thin layer of Zn using a physical vapor deposition procedure for up to a thickness of 3.2 nm. In this study, phenolic resin was used as the carbon precursor. A mixture of 54 grams (g) of phenol. 25 g orthocresol, 32.1 g of 37% formaldehyde in water solution, and 1 g of zinc acetate dehydrate was heated to 90° C. with stirring for 2 hours to form a novalac liquid. A liquid solution containing 75% of the novalac liquid mixed with 25% of divinylbenzene was prepared. Zn-coated Sn particles were then immersed in the liquid solution for 10 minutes, forming a slurry. Subsequently, methane sulfonic acid (0.5 weight percent, based on the weight of the novalac) was added to this slurry. The slurry was cured at 45° C. for 1 hour to form a highly cross-linked resin encapsulating Zn-coated Sn particles. The resin-coated composite particles were calcinated at 1,450° C. for 2 h in N₂ at a heating rate of 5° C./min to convert the resin matrix into carbon, rapidly cooled back to room temperature, and ball-milled to reduce the sizes of the carbon-protected Zn-coated Sn particles into a range of 5-26 μm.

The Sn—Zn system is known to have a eutectic point at Te=198.5° C. and Ce=85.1% Sn. A powder mass of carbon-protected Zn-coated Sn particles (15.5 μm in diameter) were heated to 220° C. and allowed to stay at 220° C. for 1 hour and then cooled down to 200° C. and maintained at 200° C. for 30 minutes. The material system was then naturally cooled to room temperature after switching off the power to the oven. Massive quantities of Sn nanowires were found to grow in the pores of carbon particles; the Sn nanowires having a diameter range of 15-26 nm.

### Example 5: Lithium-Ion Batteries Featuring Porous Carbon/Ge Nanowire and Carbon/Sn Nanowires Particulates as an Anode Active Material

For electrochemical testing, several types of anodes and cathodes were prepared. For instance, a layer-type of anode was prepared by simply coating slurry of porous carbon/Ge nanowire or carbon/Sn nanowire particulates, conductive additives, and a binder resin to form an anode layer against a sheet of Cu foil (as an anode current collector).

In one example, the working electrodes were prepared by mixing 85 wt. % active material (Ge or Sn nanowires), 7 wt. % acetylene black (Super-P, as a conductive additive), and 8 wt. % polyvinylidene fluoride (PVDF) as a binder dissolved in N-methyl-2-pyrrolidinoe (NMP). After coating the slurries on Cu foil, the electrodes were dried at 120° C. in vacuum for 2 h to remove the solvent before a compression treatment.

Then, the electrodes were cut into a disk (=12 mm) and dried at 100° C. for 24 h in vacuum. Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC 1:1 v/v). Various anode material compositions were evaluated. The cell assembly was performed in an argon-filled glove-box. The CV measurements were carried out using a CH-6 electrochemical workstation at a scanning rate of 1 mV/s. The electrochemical performance of Si nanowires was also evaluated by galvanostatic charge/discharge cycling at a current density of 50-1,000 mA/g, using a LAND electrochemical workstation. Full-cell pouch configurations using lithium iron phosphate and lithium cobalt oxide cathodes were also prepared and tested.

It may be noted that the lithium-ion battery industry has adopted a nomenclature system for a charge or discharge rate. For instance, 1 C charging means completing charging procedure in 1 hour and 2 C charging means completing charging procedure in ½ hours (30 minute). A 10 C charging rate means charging completion in 1/10 hours (6 minutes).

Experimental results indicate that the composite anode containing 85% by wt. of particulates containing Ge nanowires having a diameter of 23 nm is capable of delivering a lithium storage capacity of 1,210 mAh/g (based on the total electrode composite weight, not just the Ge weight) at 0.1 C rate and 1,076 mAh/g at 10 C rate.

Similar tends were observed for lithium-ion batteries that contain other types of semiconductor nanowires herein produced as the primary anode active material. These observations have demonstrated that smaller-diameter nanowires are significantly more high-rate capable in a lithium-ion battery. The present invention provides a cost-effective process for producing a wide variety of semiconductor nanowires.

We claim:

1. Porous carbon/semiconductor nanowire particulates, wherein at least a particulate has a particle size from 50 nm to 1 mm and comprises (i) a porous carbon matrix or shell; (ii) semiconductor nanowires dispersed in said carbon matrix or encapsulated by said carbon shell, wherein the nanowires have a diameter or thickness from 5 nm to 1 μm; and (iii) pores surrounded by or adjacent to said semiconductor nanowires; wherein said semiconductor nanowires occupy a weight fraction from 1% to 99% of the particulate and the semiconductor material and the catalytic metal form an eutectic point in a phase diagram; and wherein the pores have a non-zero residual pore volume, Vₚ, unoccupied by the carbon or semiconductor nanowires and the semiconductor nanowires have a total volume Vₙ, having a Vₚ/Vₙ ratio from 0.01 to 10.

2. The porous carbon/semiconductor nanowire particulates of claim 1, wherein the semiconductor comprises a material selected from Si, Ga, In, Ge, Sn, Pb, P, As, Sb, Bi, Te, a compound thereof, an alloy thereof, or a combination thereof.

3. The porous carbon/semiconductor nanowire particulates of claim 1, further comprising a catalyst metal that is dispersed inside said particulate and selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof, wherein said catalytic metal is different in composition than said semiconductor material.

4. The porous carbon/semiconductor nanowire particulates of claim 1, wherein said carbon comprises a carbonaceous material selected from amorphous carbon, CVD carbon, sputtering carbon, polymeric carbon, activated carbon, carbon from petroleum or coal pitch, graphite, or a combination thereof.

5. The porous carbon/semiconductor nanowire particulates of claim 1, wherein said semiconductor material and said catalytic metal form a eutectic point during a nanowire formation procedure.

6. The porous carbon/semiconductor nanowire particulates of claim 1, wherein the particulates further comprise an electron-conducting polymer or an ion-conducting polymer permeating into pores of the porous particulates wherein the ion-conducting polymer has an electric conductivity greater than 10⁻⁸ S/cm or said ion-conducting polymer has a lithium-ion or sodium-ion conductivity greater than 10⁻⁸ S/cm.

7. The porous carbon/semiconductor nanowire particulates of claim 6, wherein the ion-conducting polymer is selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer with a carboxylate anion, a sulfonylimide anion, or sulfonate anion, poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), a copolymer thereof, a sulfonated derivative thereof, or a combination thereof.

8. The porous carbon/semiconductor nanowire particulates of claim 6, wherein the electron-conducting polymer is selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

9. A battery electrode containing multiple porous carbon/semiconductor nanowire particulates of claim 1.

10. A lithium battery or sodium battery containing multiple porous carbon/semiconductor nanowire particulates of claim 1 as an anode active material.

11. A process for producing porous carbon/semiconductor nanowire particulates of claim 1, said process comprising:
(A) Preparing composite particles comprising particles of a semiconductor coated with a catalyst metal or a catalyst metal precursor, wherein the catalytic metal or the catalytic metal precursor is in the form of nano particles having a size from 1 nm to 200 nm or a coating having a thickness from 1 nm to 200 nm, coated on surfaces of said semiconductor particles, having a size of 20 nm to 1 mm, and wherein said semiconductor is selected from Si, Ga, In, Ge, Sn, Pb, P, As, Sb, Bi, Te, a compound thereof, an alloy thereof, or a combination thereof;
(B) Combining said composite particles with a carbon precursor material to form multiple carbon precursor-protected composite particles wherein a carbon precursor-protected composite particle comprises one or more than one catalytic metal- or catalytic metal precursor-coated semiconductor particles that are dispersed in a matrix of the carbon precursor or encapsulated by a shell of the carbon precursor; and
(C) exposing said multiple carbon precursor-protected composite particles to a high temperature environment, from 100° C. to 2,500° C., for a period of time sufficient to enable (i) a catalytic metal-assisted growth of multiple semiconductor nanowires, having a diameter or thickness from 2 nm to 1000 nm, from said semiconductor particles and (ii) conversion of said carbon precursor to carbon, forming said porous carbon/semiconductor nanowire particulates.

12. The process of claim 11, wherein said catalytic metal is selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof and wherein said catalytic metal is different in chemical composition than said semiconductor material.

13. The process of claim 11, wherein said step (A) of preparing composite particles comprises (a) dissolving or dispersing a catalytic metal precursor in a liquid to form a precursor solution, (b) bringing said precursor solution in contact with surfaces of said semiconductor particles, (c) removing said liquid; and (d) chemically or thermally converting said catalytic metal precursor to said catalytic metal coating or nano particles.

14. The process of claim 13, wherein said step (d) of chemically or thermally converting said catalytic metal precursor is conducted concurrently with the procedure (B) of exposing said catalyst metal-coated mixture mass to a high temperature environment.

15. The process of claim 13, wherein said catalytic metal precursor is a salt or organo-metal molecule of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

16. The process of claim 13, wherein said catalytic metal precursor is selected from a nitrate, acetate, sulfate, phosphate, hydroxide, or carboxylate of a metal selected from Cu, Ni, Co, Mn, Fe, Ti, Al, Ag, Au, Pt, Pd, Pb, Bi, Sb, Zn, Cd, Ga, In, Zr, Te, P, Sn, Ge, Si, or a combination thereof.

17. The process of claim 13, wherein said catalytic metal precursor is selected from a nitrate, acetate, sulfate, phosphate, hydroxide, or carboxylate of a transition metal.

18. The process of claim 13, wherein said catalytic metal precursor is selected from copper nitrate, nickel nitrate, cobalt nitrate, manganese nitrate, iron nitrate, titanium nitrate, aluminum nitrate, copper acetate, nickel acetate, cobalt acetate, manganese acetate, iron acetate, titanium acetate, aluminum acetate, copper sulfate, nickel sulfate, cobalt sulfate, manganese sulfate, iron sulfate, titanium sulfate, aluminum sulfate, copper phosphate, nickel phosphate, cobalt phosphate, manganese phosphate, iron phosphate, titanium phosphate, aluminum phosphate, copper hydroxide, nickel hydroxide, cobalt hydroxide, manganese hydroxide, iron hydroxide, titanium hydroxide, aluminum hydroxide, copper carboxylate, nickel carboxylate, cobalt carboxylate, manganese carboxylate, iron carboxylate, titanium carboxylate, aluminum carboxylate, or a combination thereof.

19. The process of claim 11, wherein said step of depositing a catalytic metal is conducted by a procedure of physical vapor deposition, chemical vapor deposition, sputtering, plasma deposition, laser ablation, plasma spraying, ultrasonic spraying, printing, electrochemical deposition, electrode plating, electrodeless plating, chemical plating, ball milling, or a combination thereof.

20. The process of claim 11, wherein said procedure of exposing said catalyst metal-coated semiconductor material to a high temperature environment is conducted in a protective atmosphere of an inert gas, nitrogen gas, hydrogen gas, a mixture thereof, or in a vacuum.

21. The process of claim 11, wherein said semiconductor material and said catalytic metal form an eutectic point and said procedure of exposing said catalyst metal-coated semiconductor material to a high temperature environment comprises exposing said material to a temperature equal to or higher than said eutectic point for a desired period of time and then bringing said material to a temperature below said eutectic point.

22. The process of claim 21, wherein said exposure temperature is higher than said eutectic temperature by 0.5 to 500 degrees centigrade.

23. The process of claim 11, wherein said carbon precursor is selected from a polymer, petroleum pitch, coal tar pitch, meso-phase pitch, a polynuclear hydrocarbon, or a combination thereof.

24. The process of claim 11, wherein said polynuclear hydrocarbon is selected from naphthalene, anthracene, phenanthrene, tetracene, chrysene, triphenylene, pyrene, pentacene, benzo-pyrene, corannulene, benzo-perylene, coronene, ovalene, benzo-fluorene, a derivative thereof having a substituent on a ring structure thereof, a chemical derivative thereof, or a combination thereof.

25. The process of claim 11, further comprising a procedure of mixing said porous carbon/semiconductor nanowire particulates with a carbonaceous or graphitic material as a conductive additive to form an electrode layer, wherein said carbonaceous or graphitic material is selected from a chemical vapor deposition carbon, physical vapor deposition carbon, amorphous carbon, chemical vapor infiltration carbon, polymeric carbon or carbonized resin, pitch-derived carbon, natural graphite, artificial graphite, meso-phase carbon, meso-phase pitch, meso-carbon micro-bead, soft carbon, hard carbon, coke, or a combination thereof.

26. The process of claim 25, wherein the mixing of said porous carbon/semiconductor nanowire particulates with the carbonaceous or graphitic material as the conductive additive to form an electrode layer further includes adding a binder material into the mixing.

27. The process of claim 11, further comprising a procedure of impregnating pores of the porous carbon/semiconductor nanowire particulates with an ion-conducting or electron-conducting polymer.
